(19) United States
(12) Patent Application Publication
(10) Pub. No.: US 2013/0284491 A1
(43) Pub. Date: Oct. 31, 2013

(54) ZERO HALOGEN CABLE

(71) Applicant: General Cable Technologies Corporation, Highland Heights, KY (US)

(72) Inventors: Scott M. BROWN, Independence, KY (US); Matthew S. MCLINN, Covington, KY (US); Robert S. GOULD, Cincinnati, OH (US); Shaun MILLER, Lexington, KY (US); Richard CHAMBERLAIN, Lawrenceburg, KY (US); Alice C. ALBRINCK, Hebron, KY (US)

(21) Appl. No.: 13/924,020

(22) Filed: Jun. 21, 2013

Related U.S. Application Data
(62) Division of application No. 13/184,964, filed on Jul. 18, 2011.
(60) Provisional application No. 61/370,002, filed on Aug. 2, 2010.

(51) Int. Cl. H01B 7/295

(52) U.S. Cl. CPC H01B 7/295
USPC 174/113 R

(57) ABSTRACT

A cable that comprises a cable core that includes a plurality of insulated pairs of twisted conductors wherein, the insulation of at least one pair of the plurality of insulated pairs of twisted conductors has inner and outer layers, the inner layer being formed of a zero halogen material that is not flame retardant, the outer layer being formed of a zero halogen material that is substantially flame retardant, and the insulation of at least another pair of the plurality of insulated pairs of twisted conductors is formed of a zero halogen material that is not flame retardant.

### RELATED APPLICATION

This application is a divisional of U.S. patent application Ser. No. 13/184,964, filed Jul. 18, 2011 which claims priority under 35 U.S.C. §119 to Provisional Application Ser. No. 61/370,002, filed on Aug. 2, 2010, the subject matter each of which is hereby incorporated by reference.

### FIELD OF THE INVENTION

The present invention relates to a zero halogen cable, such as a data cable, that provides enhanced burn characteristics achieved using a combination of halogen free materials, such as polyolefin and polyolefin blends with varying degrees of flame retardency.

### BACKGROUND OF THE INVENTION

Conventional cables typically include a number of insulated wire pairs and a jacket surrounding those wire pairs. Cables must pass burn tests, such as Underwriters Laboratories UL-1666 burn test, in order to obtain a CMR rating for communications cable. Manufacturers typically cannot make a cost effective zero halogen construction that exhibits similar form, fit and function of conventional fire rated halogenated cables. Attempts to make a zero halogen cable construction that is flexible, has higher tensile strength and uses lower cost materials have failed the UL-1666 burn test.

A number of cable manufacturers use halogenated materials, such as polyvinylchlorides (PVC), in their cable constructions in order to meet industry burn and flame requirements. Although such halogenated materials provide good flame suppression, when a halogenated cable catches fire, toxins, such as chlorine, are released into the environment as a gas. Such gas if inhaled could cause adverse health effects. Also, adding flame retardants sufficient to pass flame suppression requirements makes the cable stiffer. In addition, use of non-halogenated materials for a cable jacket results in a cable that is not cost effective and yields stiff and inflexible jacket characteristics.

Thus, there is a need for a cost-competitive zero halogen cable construction that meets fire (e.g. UL 1666 CMR), electrical (e.g. ANSI/TIA-568) and physical (e.g. UL444, Telcordia 3164, ICEA S-90-661, ICEA S-102-700) requirements per industry standards, and that may also exhibit improved flexibility over commercially available non-halogenated products.

### SUMMARY OF THE INVENTION

Accordingly, the present invention provides a cable that has a cable core that includes a plurality of insulated pairs of twisted conductors. The insulation of at least one pair of the plurality of insulated pairs of twisted conductors may be a zero halogen material that is flame retardant, and the insulation of at least another pair of the plurality of insulated pairs of twisted conductors may be a zero halogen material that is not flame retardant. A jacket of the cable may also be a zero halogen material.

The present invention also provides a cable that has a cable core that includes a plurality of insulated pairs of twisted conductors. The insulation of at least one pair of the plurality of insulated pairs of twisted conductors may be a mixture of a zero halogen material that is flame retardant and a zero halogen material that is not flame retardant. The insulation of at least another pair of the plurality of insulated pairs of twisted conductors is a zero halogen material that is not flame retardant.

The present invention also provides a cable that has a cable core that includes a plurality of insulated pairs of twisted conductors. At least one pair of the plurality of insulated pairs of twisted conductors has insulation with a portion thereof that is a zero halogen material that is flame retardant. The insulation of at least another pair of the plurality of insulated pairs of twisted conductors is a zero halogen material that is not flame retardant.

The present invention may also provide a cable that has a cable core including a plurality of insulated non-paired conductors. The insulation of at least one conductor of the plurality of insulated non-paired conductors may be a zero halogen material that is flame retardant, and the insulation of at least another conductor of the plurality of insulated non-paired conductors is a zero halogen material that is not flame retardant.

The present invention may also provide a cable that has a cable core that includes a plurality of insulated non-paired conductors. The insulation of at least one conductor of the plurality of insulated non-paired conductors may be a mixture of a zero halogen material that is flame retardant and a zero halogen material that is not flame retardant. And the insulation of at least another conductor of the plurality of insulated non-paired conductors is a zero halogen material that is not flame retardant.

The present invention may also provide a cable that has a cable core that includes a plurality of insulated non-paired conductors. At least one conductor of the plurality of insulated non-paired conductors has insulation with a portion thereof that may be a zero halogen material that is flame retardant. The insulation of at least another conductor of the plurality of insulated non-paired conductors is a zero halogen material that is not flame retardant.

The present invention may also provide a cable that has a cable core that includes a plurality of insulated non-paired conductors. The insulation of at least one conductor of the plurality of insulated non-paired conductors has inner and outer layers. The inner layer may be a zero halogen material that is not flame retardant and the outer layer may be a zero halogen material that is flame retardant. The insulation of at least another conductor of said plurality of insulated non-paired conductors is a zero halogen material that is not flame retardant.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIGS. 1A-1C are each a cross sectional view of a cable according to a first exemplary embodiment of the present invention;

FIG. 2 is a cross sectional view of a cable according to a second exemplary embodiment of the present invention;

FIG. 3 is a cross sectional view of a cable according to a third exemplary embodiment of the present invention;

FIG. 4 is a cross sectional view of a cable according to a fourth exemplary embodiment of the present invention; and

FIG. 5 is a cross sectional view of a cable according to a fifth exemplary embodiment of the present invention.

### DETAILED DESCRIPTION OF THE EXEMPLARY EMBODIMENTS OF THE INVENTION

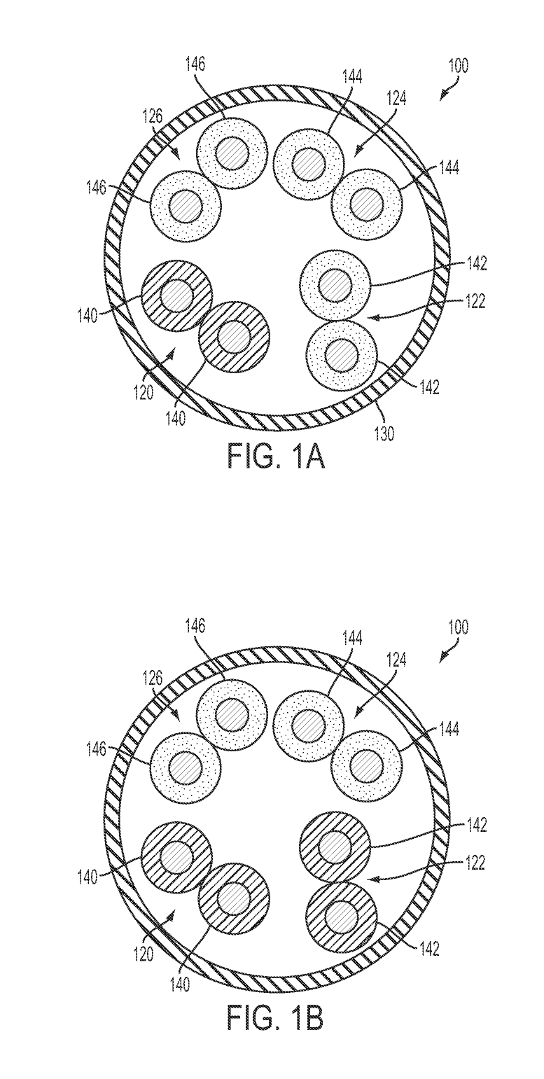

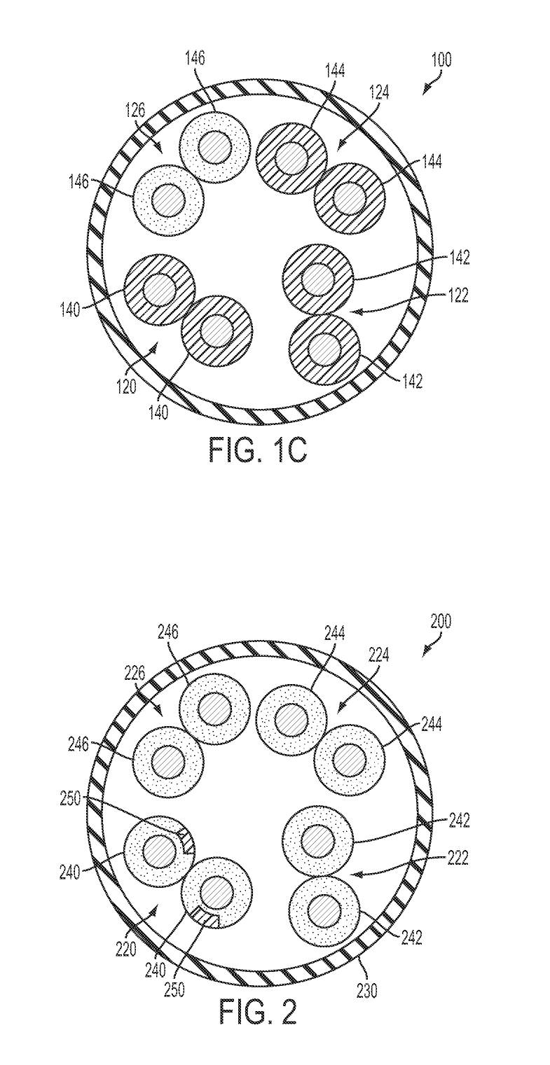

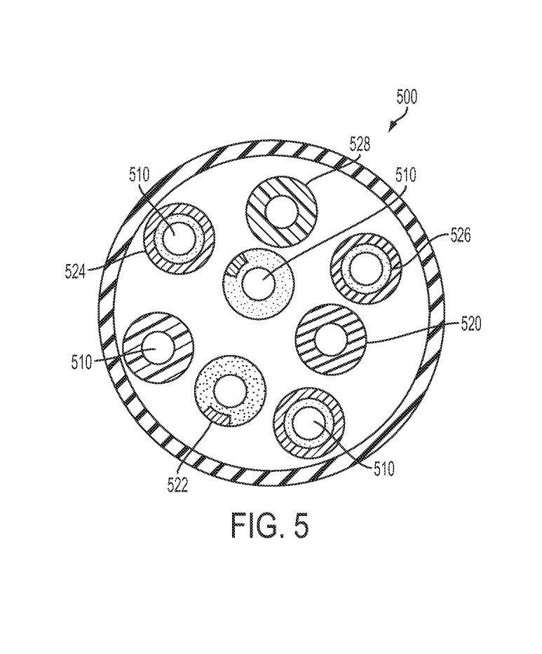

Referring to FIGS. 1A, 1B, 1C, and 2-5, the present invention relates to a cable construction that combines (1) one or more conductors that are insulated with a material that is zero halogen and also flame retardant with (2) one or more conductors that are insulated with a zero halogen material that is not flame retardant. The conductors may be twisted into pairs (e.g. FIG. 1A) or may be individual conductors (FIG. 5). Such a cable construction is both halogen free and meets industry standards for flame suppression, particularly for riser (floor-to-floor) cables. Although this zero halogen concept would make a CMR rated riser cable more expensive, it has the benefit of an entirely zero halogen construction while still meeting industry burn test requirements. That is, by adding additional flame suppressants to the insulation material of the core cable construction by use of a highly flame retardant or viscosity-modified zero halogen pair or pairs, the likelihood of meeting UL's flame spread requirements (UL 1666) is increased. Moreover, the addition of flame suppressing material to the inner core of the cable allows use of a more, cost effective, flexible, zero halogen outer jacket to protect the cable. The cable of the present invention is designed to be used primarily as a transmission cable (solid or stranded); however, it may be used as any cable required to meet CMR UL1666 (NEC NFPA 70) flame test or CMR test requirements for cable safety ratings.

Referring to FIG. 1A, a cable 100 according to an exemplary embodiment includes a plurality of pairs of conductors twisted together, for example, first, second, third and fourth pairs, 120, 122, 124, and 126, to form an inner core that is surrounded by a jacket 130. The conductors of each pair 120, 122, 124 and 126 include insulation 140, 142, 144 and 146, respectively. In order to provide a halogen free cable construction, the insulation 140, 142, 144 and 146 of each pair 120, 122, 124 and 126 is formed of a zero halogen material. Zero halogen means the material is non-halogenated and/or total ppm of accidental trace halogens as defined by applicable industry standards for zero halogen materials. As seen in FIG. 1A, the material of the insulation 140 of at least one pair 120 may also be flame retardant. For example, the insulation 140 may be a flame retardant polyolefin. Flame retardant polyolefins may include for example, polyethylene, polypropylene, ethylene-propylene copolymer, ethylene-vinyl acetate, ethylene-ethyl acrylate, ethylene-methyl acrylate, copolymers containing ethylene monomeric units and terpolymers containing ethylene monomeric units. Also, non-porous micro oxide particles, such as silicone dioxide particles (described in commonly assigned U.S. application Ser. No. 13/044,974, filed Mar. 10, 2011, entitled Insulation With Micro Oxide Particles, the subject matter of which is incorporated herein by reference), may be added to a standard zero halogen material to provide the flame retardancy. Alternatively, the insulation may be a mixture of highly flame retardant or viscosity-modified zero halogen material and standard zero halogen material, such as polyolefin. The mixture may be, for example, 20% of the zero halogen flame retardant material and 80% of a standard non-flame retardant material like polyolefin.

The insulation 142, 144 and 146 for the remaining pairs 122, 124 and 126 may be a standard, and less expensive, non-flame retardant zero halogen material, such as polyethylene or non-flame retardant polyolefin. Examples of non-flame retardant polyolefins may include low cost thermoplastics, polyethylene, polypropylene, ethylene-propylene copolymer, ethylene-vinyl acetate, ethylene-ethyl acrylate, ethylene-methyl acrylate, copolymers containing ethylene monomeric units, terpolymers containing ethylene monomeric units, or the like. The combination of zero halogen insulation materials that are both flame retardant and non-flame retardant in the cable core provides a cable construction that is both totally halogen free and meets flame suppression requirements. It is preferable that the cable's jacket 130 also be formed of a zero halogen insulating material. The jacket material may be a standard (non-flame retardant) zero halogen material, a flame retardant zero halogen material, or a mixture of both.

FIGS. 1B and 1C illustrate other examples of the above combination. FIG. 1B shows that the insulation 140 and 142 of at least two of the pairs 120 and 122 of the cable core is formed with a flame retardant zero halogen material where the insulation 144 and 146 of the remaining pairs 124 and 126 is a non-flame retardant zero halogen material. Similarly, FIG. 1C shows that the insulation 140, 142 and 144 of at least three of the pairs 120, 122, and 124 is formed with a flame retardant zero halogen material and the insulation 146 of the remaining pair 126 is a non-flame retardant zero halogen material. Although not illustrated, the cable construction of the present invention may be applied to any pair count of the cable core, e.g. two pair [1×1], three pair [2×1 or 1×2], four pair [3×1, 2×2, 1×3], six pair, etc.

Referring to FIG. 2, a cable 200 according to another embodiment of the present invention is similar to the first embodiment, except that only a portion of the conductor insulation is a zero halogen that is flame retardant material. Preferably, the portion of insulation is a highly flame retardant material, such as flame, viscosity modified group consisting of polyethylene, polypropylene, ethylene-propylene copolymer, ethylene-vinyl acetate, ethylene-ethyl acrylate, ethylene-methyl acrylate, copolymers containing ethylene monomeric units, terpolymers containing ethylene monomeric unit, or the like. Like the cable of the first embodiment, the cable 200 has four conductor pairs 220, 222, 224, and 226 that form a core surrounded by a jacket 230. The conductors of each pair 220, 222, 224 and 226 include insulation 240, 242, 244 and 246, respectively. Similar to the first embodiment, the insulation 240 of at least one conductor pair 220 has a portion that is a flame retardant zero halogen material. For example, that portion may be a longitudinal strip 250, as seen in FIG. 2. The remaining material of the insulation 240 may be a standard non-flame retardant zero halogen material. The portion or strip 250 may be added to any of the insulation 242, 244, and 246 of the other conductor pairs 222, 224 and 226. By adding the strip 250 of flame retardant material to one or more pairs of the cable 200, the cable 200 remains halogen free while also providing flame suppression to meet industry requirements. Like the jacket 130 of the first embodiment, the jacket 230 is also preferably made of a zero halogen material that may be either flame retardant or not, or a mixture of both.

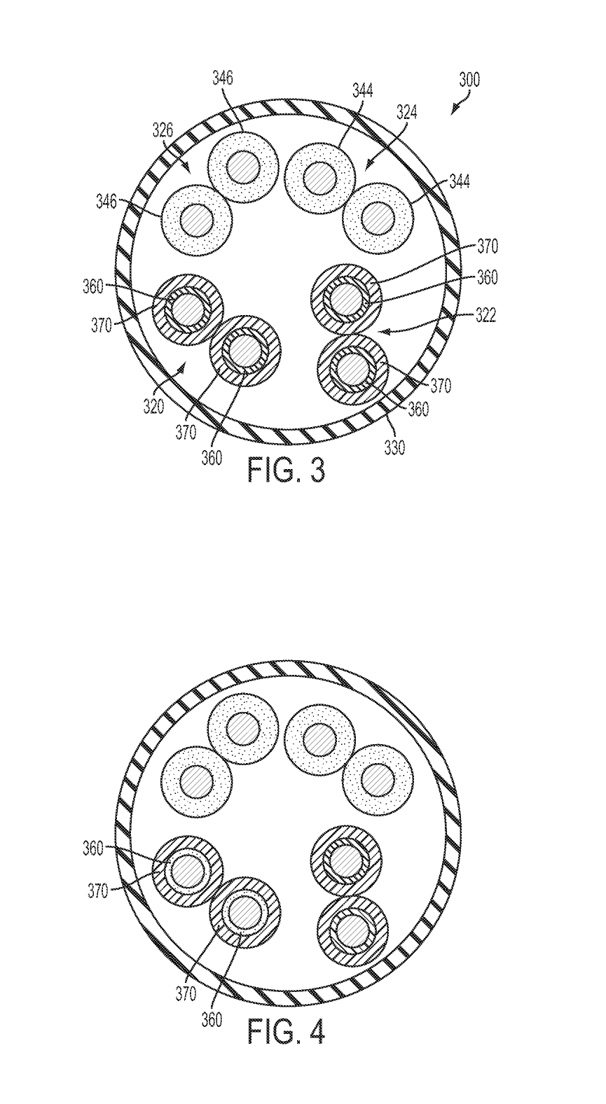

Referring to FIG. 3, a cable 300 according to yet another exemplary embodiment of the present invention provides a dual layer of insulation for at least one conductor pair where the outer layer may be a flame retardant material. In particular, the insulation 340 and 342 of the conductor pairs 320 and 322 has an inner layer 360 and an outer layer 370. The inner layer 360 of the insulation may be a standard zero halogen material that is not flame retardant. The outer layer 370 surrounds the inner layer 360 and is preferably a flame retardant zero halogen material, like the material described above with respect to the first embodiment. The insulation 344 and 346 of the remaining conductor pairs 324 and 326 may be a single layer of standard zero halogen material. Although two conductor pairs 320 and 322 are shown with a dual layer of insulation, any number of the conductor pairs 320, 322, 324, and 326 may have a dual layer of insulation as described above, including just one conductor pair. A jacket 330 surrounding the conductor pairs is preferably formed of a zero halogen material that may be either flame retardant or not, or a mixture of both. The jacket 330 may also have two or more layers. For example, an outer layer of the jacket could be formed of a highly flame retardant zero halogen material and/or outer layer silicon dioxide an inner layer may be a micro oxide particle modified insulation.

As seen in FIG. 4, the inner layer 360 may be foamed. The outer layer 370 may also be foamed. Moreover, the insulation of the conductor pairs of any of the embodiments described herein may be entirely or partially foamed.

Referring to FIG. 5, a cable 500 according to yet another embodiment of the invention includes individual conductors 510 instead of pairs of conductors. Each conductor 510 is insulated with zero halogen material. And at least one of those conductors is insulated with a flame retardant zero halogen material in the same manner as described above with respect to the first through fourth embodiments. For example, the insulation for one or more conductors 510 may be one of a solid zero halogen flame retardant material (insulation 520) similar to the first embodiment; may have only a portion or strip of flame retardant material (insulation 522) similar to the second embodiment; may be dual layers with at least the outer layer being flame retardant (insulation 524) similar to the third embodiment; may have a portion or layer that is foamed (insulation 526) similar to the fourth embodiment; or may be entirely foamed (insulation 528). Any number of the conductors 510 may be insulated with a flame retardant zero halogen material as described above in any combination. As with the other embodiments, the insulation for the remaining conductors 510 is preferably standard zero halogen material that is not flame retardant.

Cable accessories (not shown), such as separators, crosswebs, shields, screens, foils, barriers and the like, may also be used with the cables of the present invention. Like the jackets of the above embodiments, the cable accessories are preferably made of a zero halogen material that is not flame retardant, flame retardant, or a mixture of both.

While particular embodiments have been chosen to illustrate the invention, it will be understood by those skilled in the art that various changes and modifications can be made therein without departing from the scope of the invention as defined in the appended claims. For example, any number of conductor pairs or conductors may be used with the cables of the present invention, and is not limited to four pairs or eight conductors as illustrated.

What is claimed is:

1. A cable, comprising:
a cable core including:
a plurality of insulated pairs of twisted conductors wherein,
said insulation of at least one pair of said plurality of insulated pairs of twisted conductors has inner and outer layers, said inner layer being formed of a zero halogen material that is not flame retardant, said outer layer being formed of a zero halogen material that is substantially flame retardant, and said insulation of at least another pair of said plurality of insulated pairs of twisted conductors is formed of a zero halogen material that is not flame retardant.

2. A cable according to claim 1, further comprising
a jacket surrounding said plurality of insulated pairs of twisted conductors, said jacket being formed of a zero halogen material.

3. A cable according to claim 2, wherein
said zero halogen material of said jacket is a mixture of substantially flame retardant material and non-flame retardant material.

4. A cable according to claim 1, wherein
said plurality of said insulated pairs of twisted conductors includes three pairs with insulation that is formed of a zero halogen material that is not flame retardant.

5. A cable according to claim 1, wherein
said plurality of said insulated pairs of twisted conductors includes two pairs with insulation that is formed of said inner and outer layers and two pairs with insulation that is formed of zero halogen material that is not flame retardant.

6. A cable according to claim 1, wherein
said outer layer is formed of a flame retardant polyolefin.

7. A cable according to claim 6, wherein
said insulation of said another pair of said plurality of insulated pairs of twisted conductors is formed of a non-flame retardant polyethylene.

8. A cable according to claim 1, further comprising
a separator disposed between said plurality of insulated pairs of twisted conductors, said separator being formed of a zero halogen material.

9. A cable, comprising:
a cable core including:
a plurality of insulated conductors wherein,
said insulation of at least one conductor of said plurality of insulated conductors having inner and outer layers, said inner layer being formed of a zero halogen material that is not flame retardant, said outer layer being formed of a zero halogen material that is substantially flame retardant, and said insulation of at least another conductor of said plurality of insulated non-paired conductors is formed of a zero halogen material that is not flame retardant.

10. A cable according to claim 9, further comprising
a jacket surrounding said plurality of insulated conductors, said jacket being formed of a zero halogen material.

11. A cable according to claim 9, wherein
said plurality of said insulated conductors includes at least one conductor with insulation that has said inner and outer layers and a plurality of other conductors with insulation that is formed of a zero halogen material that is not flame retardant.

12. A cable according to claim 9, wherein
said plurality of said insulated conductors includes at least two conductors with insulation that has said inner and outer layers and at least one other conductor with insulation that is formed of a zero halogen material that is not flame retardant.

13. A cable according to claim 9, wherein
said outer layer is formed of a flame retardant polyolefin.

14. A cable according to claim 13, wherein
said inner layer is formed of a non-flame retardant polyethylene.
